(19) United States
(12) Patent Application Publication
(10) Pub. No.: US 2026/0147817 A1
(43) Pub. Date: May 28, 2026

(54) DATABASE APPARATUS, DATA RETRIEVAL METHOD, AND DATABASE SYSTEM

(71) Applicant: Hitachi, Ltd., Tokyo (JP)

(72) Inventors: Yoshiki KUROKAWA, Tokyo (JP); Kazuhiko MOGI, Tokyo (JP); Norifumi NISHIKAWA, Tokyo (JP); Daiki TAKAO, Tokyo (JP)

(21) Appl. No.: 19/325,369

(22) Filed: Sep. 10, 2025

(30) Foreign Application Priority Data
Nov. 25, 2024 (JP) 2024-204382

(51) Int. Cl. G06F 16/355; G06F 16/31; G06F 16/334

(52) U.S. Cl. CPC G06F 16/355; G06F 16/31; G06F 16/334

(57) ABSTRACT

A database apparatus, method, and system capable of balancing reliability of retrieval and a processing speed are provided. The database apparatus includes a centroid determination module that divides first vector data into a plurality of clusters through clustering and determines centroids, the first vector data obtained by vectorizing chunks, the chunks being obtained by dividing a document, an index creation module that creates a list of the first vector data included in the clusters and in a predetermined area across a boundary of the clusters, and a vector neighborhood ranking module that upon retrieval of the first vector data close to second vector data created for a query, performs comparison by using the first vector data included in a cluster to which the second vector data belongs and the first vector data included in the predetermined area set for a boundary of the cluster to which the second vector belongs.

### CROSS REFERENCE TO RELATED APPLICATION

This application relates to and claims the benefit of priority from Japanese Patent Application number 2024-204382, filed on Nov. 25, 2024 the entire disclosure of which is incorporated herein by reference.

### BACKGROUND OF THE INVENTION

### Field of the Invention

The present invention relates to a database apparatus, a data retrieval method, and a database system. The present invention particularly relates to a database apparatus to be used upon retrieval of vector data.

### Description of the Related Art

In recent years, with the development of a large language models (LLM), there has been an increasing demand for a vector database to be used for retrieval-augmented generation (RAG).

Patent Literature 1 discloses a clustering apparatus that allocates a plurality of feature vectors respectively arranged on a spherical surface to a plurality of clusters by iterative procedure. The clustering apparatus includes similarity calculation means for calculating a similarity between a feature vector and a representative vector of each of the plurality of clusters for each of the feature vectors, and determination means for determining whether or not a similarity is to be calculated when the number of times of repetition reaches the t-th time. The determination means determines whether or not to calculate the similarity when the number of times of repetition reaches the t-th time using at least an upper limit value when the number of times of repetition is the (t−1)-th time, the upper limit value being calculated for the similarity based on an angle formed by the feature vector and the representative vector. The similarity calculation means does not calculate the similarity when the number of times of repetition reaches the t-th time in a case where it is determined by the determination means that the similarity will not be calculated.

Patent Literature 2 discloses a verification apparatus that verifies correspondence between two images. In the verification apparatus, a feature extraction unit obtains an output of a convolutional layer for each partial area by applying a convolutional neural network for each of the two images. A correspondence candidate calculation unit obtains a cosine similarity of the output of the convolutional layer for each combination of a partial area of one image and a partial area of the other image, and in a case where the cosine similarity exceeds a threshold in its value, the partial area of the other image having a maximum cosine similarity with respect to a partial area A coincides with a partial area B, and the partial area of the one image having a maximum cosine similarity with respect to a partial area B coincides with the partial area A, selects a combination of the partial area A of the one image and the partial area B of the other image as a correspondence candidate. A verification unit determines suitability of the correspondence candidate based on position coordinates of the partial area for each correspondence candidate and outputs the correspondence candidate as a correspondence in a case where the correspondence candidate is suitable.

### CITATION LIST

### Patent Literature

Patent Literature 1: JP 2019-121044 A

Patent Literature 2: JP 2019-28700 A

A vector database operates so as to acquire vectors in the vicinity of a high-dimensional vector that serves as a query, corresponding to the designated number in ascending order of a distance.

In this event, a calculation amount becomes enormous if distances to all the stored vectors are calculated, and thus, processing load is reduced, and a higher speed is achieved by creating indexes in advance and calculating distances only for vector data considered to be close to the vector data of the query upon retrieval.

However, with this method, in a case where emphasis is placed on reliability of retrieval, processing becomes heavy, and a retrieval speed is likely to be lowered.

An object of the present invention is to provide a database apparatus, a data retrieval method, and a database system capable of balancing reliability of retrieval and a processing speed.

### SUMMARY OF THE INVENTION

The present invention for solving the above-described problem is a database apparatus including a clustering unit that divides first vector data into a plurality of clusters through clustering and determines a centroid of each of the clusters, the first vector data being data obtained by vectorizing chunks, the chunks being obtained by dividing a document, a list creation unit that creates a list of the first vector data belonging to the clusters and the first vector data included in a predetermined area across a boundary of the clusters, and a retrieval unit that, upon retrieval of the first vector data close to second vector created for a query by performing comparison between the first vector data and the second vector data based on the list, performs the comparison by using the first vector data included in a cluster to which the second vector data belongs and the first vector data included in the predetermined area set for a boundary of the cluster to which the second vector data belongs. In this case, it is possible to provide a database apparatus capable of balancing reliability of retrieval and a processing speed.

Here, for example, the list creation unit determines the first vector data included in the predetermined area based on a position of the centroid and a position of the boundary. In this case, the first vector data located close to the boundary can be extracted.

Further, for example, the list creation unit determines the first vector data included in the predetermined area based on distances between the first vector data, and the position of the centroid and the position of the boundary. In this case, the first vector data located close to the boundary can be extracted from the distances in a vector space.

Still further, for example, the list creation unit determines the first vector data included in the predetermined area based on a cosine similarity defined based on a relationship between the first vector data and the position of the centroid. In this case, the first vector data located close to the boundary can be extracted by the cosine similarity between two centroids and the first vector data.

Yet further, for example, the retrieval unit performs the comparison by further using all the first vector data included in a cluster adjacent to the cluster to which the second vector data belongs, the cluster being defined based on a position of the centroid.

Then, for example, the retrieval unit distinguishes between a case where all the first vector data included in the cluster adjacent to the cluster to which the second vector data belongs is used, and a case where the first vector data included in the predetermined area set for the cluster to which the second vector data belongs is used. In this case, even in a case where the reliability of retrieval is improved, the processing speed is less likely to decrease.

Further, for example, the retrieval unit uses all the first vector data included in the cluster adjacent to the cluster to which the second vector data belongs for clusters corresponding to the number determined in advance in ascending order of distance from the position of the centroid, and uses the first vector data included in the predetermined area set for the cluster to which the second vector data belongs for the remaining clusters. In this case, the reliability of retrieval is improved by using all the first vector data for the clusters for which the first vector data close to the second vector data is highly likely to exist, and the processing speed is improved by performing retrieval only in the predetermined area for the clusters for which the first vector data close to the second vector data is less likely to exist.

Further, for example, the list creation unit creates a first table indicating whether or not the first vector data exists in the predetermined area as a relationship between the centroids or between the clusters, and the retrieval unit determines whether or not the first vector data included in the predetermined area is to be retrieved by referring to the first table. In this case, it is possible to easily determine whether or not retrieval is to be performed for the predetermined area.

Still further, for example, the list creation unit creates a second table indicating a list of the first vector data included in the predetermined area as a relationship between the centroids or between the clusters, and the retrieval unit specifies a list of the first vector data included in the predetermined area by referring to the second table. In this case, it is possible to know existence of the first vector data included in the predetermined area.

Then, for example, the retrieval unit creates a third table indicating whether or not the predetermined area has been used for retrieval as a relationship between the centroids or between the clusters and prevents comparison for the predetermined area from being performed in an overlapped manner by referring to the third table. In this case, the processing speed upon retrieval is improved.

Further, the present invention is a data retrieval method to be performed by a processor executing a program recorded in a memory, the data retrieval method including dividing first vector data into a plurality of clusters through clustering and determining a centroid of each of the clusters, the first vector data being data obtained by vectorizing chunks, the chunks being obtained by dividing a document, creating a list of the first vector data belonging to the clusters and the first vector data included in a predetermined area across a boundary of the clusters, and upon retrieval of the first vector data close to second vector data created for a query by performing comparison between the first vector data and the second vector data based on the list, performing the comparison by using the first vector data included in a cluster to which the second vector data belongs and the first vector data included in the predetermined area set for a boundary of the cluster to which the second vector data belongs. In this case, it is possible to provide a data retrieval method capable of balancing reliability of retrieval and a processing speed.

Still further, the present invention is a database system including a terminal apparatus to which a client inputs a query, a document management apparatus that divides a document into chunks, and a database apparatus that retrieves the chunks close to the query, the database apparatus including a clustering unit that divides first vector data that is data obtained by vectorizing the chunks, into a plurality of clusters through clustering and determines a centroid of each of the clusters, a list creation unit that creates a list of the first vector data belonging to the clusters and the first vector data included in a predetermined area across a boundary of the clusters, and a retrieval unit that upon retrieval of the first vector data close to second vector data created for the query by performing comparison between the first vector data and the second vector data based on the list, performs the comparison by using the first vector data included in a cluster to which the second vector data belongs and the first vector data included in the predetermined area set for a boundary of the cluster to which the second vector data belongs. In this case, it is possible to provide a database system capable of balancing reliability of retrieval and a processing speed.

According to the present invention, it is possible to provide a database apparatus, a database retrieval method, and a database system capable of balancing reliability of retrieval and a processing speed.

### BRIEF DESCRIPTION OF THE DRAWINGS

FIG. 1 is a view illustrating schematic operation of a database system according to the present embodiment;

FIG. 2(a) to 2(c) are views illustrating operation of search space reduction-type (Ivfflat) index calculation in related art;

FIG. 3(a) is a view illustrating a case where an omission in selection occurs in a case where only one for which a centroid point is the closest is selected, and FIG. 3(b) is a view illustrating a method for creating clusters to which the present embodiment is applied;

FIG. 4 is a view for explaining a method for selecting vector data falling within a predetermined area;

FIG. 5 is a view illustrating a hardware configuration and a functional configuration of a vector database server;

FIG. 6 is a view illustrating a data structure of a data page to be used in the present embodiment;

FIG. 7 is a view indicating a data structure of an adjacent centroid table;

FIG. 8 is a view indicating a data structure of an adjacent centroid page table;

FIG. 9 is a view indicating a data structure of an adjacent centroid use flag table;

FIG. 10 is a flowchart for explaining operation of an import execution module of the vector database server;

FIG. 11 is a flowchart for explaining operation of a query execution module of the vector database server;

FIG. 12 is a view illustrating processing in the case of mixture of a case where retrieval is performed for all adjacent clusters and a case where retrieval is performed only for set predetermined areas at boundaries K with the adjacent clusters;

FIG. 13 is a view illustrating a method for selecting first vector data falling within a predetermined area based on a cosine similarity defined based on a relationship between the first vector data and positions of centroids; and

FIG. 14 is a flowchart for explaining operation of an import execution module in a second embodiment.

### DETAILED DESCRIPTION OF THE INVENTION

Embodiments of the present invention will be described in detail below with reference to the accompanying drawings. The present invention will be described below using a first embodiment and a second embodiment.

### First Embodiment

### <Explanation of Schematic Operation of Database System 100>

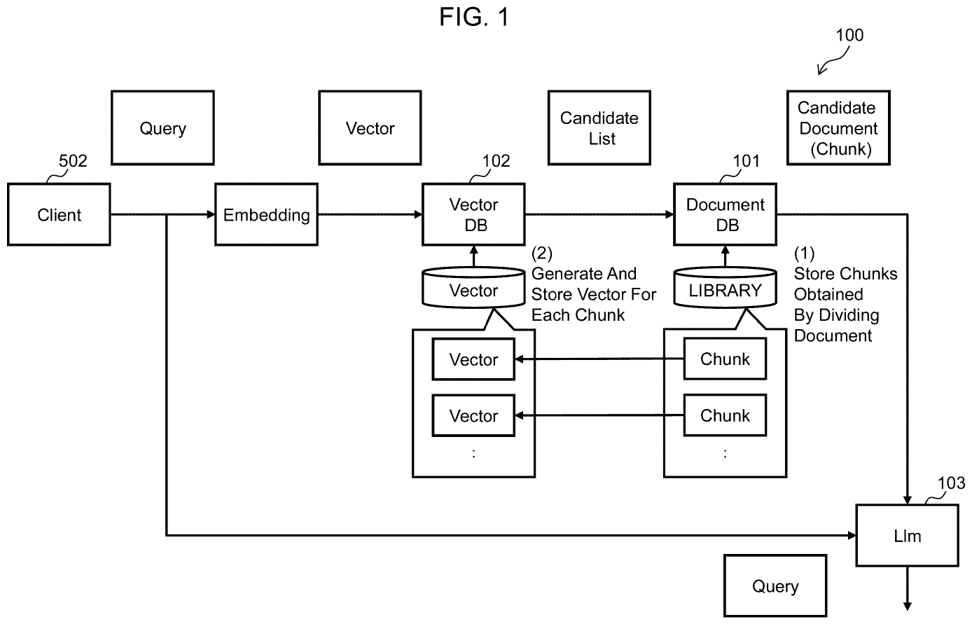

FIG. 1 is a view illustrating schematic operation of a database system 100 of the present embodiment.

The illustrated database system 100 is an apparatus that outputs an answer to a query input by a client 502.

A document DB (database) 101 is one example of a document management apparatus that divides a document into chunks. The document DB 101 acquires data of the document from a library and stores the document that is divided into chunks. The document is not particularly limited, but, for example, a specification document. The chunk is a unit of dividing the document so as to be easily handled and is obtained by dividing the document into, for example, in units of sentence, paragraph, word, phrase, or the like.

A vector DB (database) 102 performs embedding for each chunk to generate and store vector data. The embedding is operation for converting the chunk into vector expression. By this means, the chunk is converted into vector data.

On the other hand, the client 502 that utilizes the database system 100 inputs a query using a terminal apparatus held by the client 502. The query is a keyword or a phrase to be used to retrieve information. The query transmitted to the database system 100 is subjected to embedding, thereby converted into vector expression. By this means, the query is converted into vector data.

The vector DB 102 is one example of a database apparatus that retrieves a chunk close to the query. The vector DB 102 compares the vector data generated from the query with vector data generated from the chunks obtained by dividing the document and finds vector data close to the former vector data among the latter vector data through retrieval. In this case, a chunk having meaning close to meaning of the query is found by retrieving vector data for which a distance in a vector space is close. Further, a predetermined number of pieces of vector data found in ascending order of distance are transmitted to the document DB 101 as a candidate list. In the document DB 101, chunks corresponding to the candidate list are taken out from the document DB 101 and output to an LLM 103 as a candidate document (chunks).

The LLM 103 generates an answer to the query based on the candidate document (chunks) and transmits the answer to the client 502.

Here, if distances of all the stored vector data are calculated, a calculation amount becomes enormous. Thus, indexes are created in advance for the vector data for which the chunks are generated by dividing the document, and upon retrieval, index calculation in which distances are calculated only for vector data that is considered to be close from the vector data of the query is performed based on the indexes. As the index calculation, in the present embodiment, a search space reduction-type (Ivfflat) method is used.

Note that hereinafter, the vector data for which the chunks are generated by dividing the document may be referred to as “first vector data”. Further, hereinafter, the vector data generated from the query may be referred to as “second vector data”.

### <Explanation of Index Calculation>

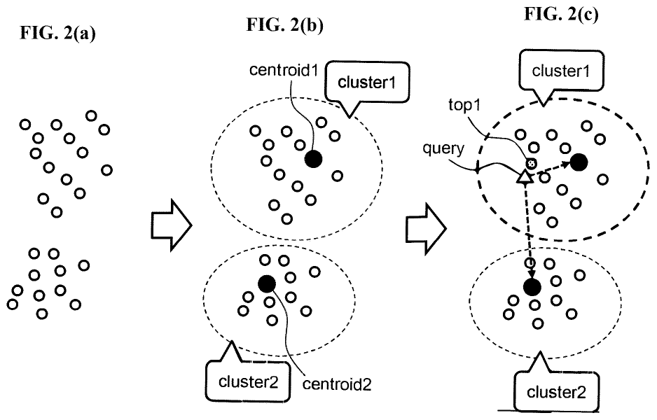

FIG. 2(a) to 2(c) are views illustrating operation of search space reduction-type (Ivfflat) index calculation in related art.

FIG. 2(a) indicates that a number of pieces of the first vector data indicated by white circles exist in the vector space. This vector space is a multidimensional space, and, for example, a 128-dimensional space.

FIG. 2(b) is a view illustrating processing upon index creation. Here, the first vector data is divided into clusters indicated by dotted lines using a k-means method which is one of the clustering methods, and centroid points (centroids) of the clusters are registered as indexes, and a list of the first vector data belonging to the clusters having the centroid points is created. FIG. 2(b) indicates that the first vector data is divided into clusters indicated as a cluster 1 and a cluster 2, and the centroids of the clusters are a centroid 1 and a centroid 2, respectively.

FIG. 2(c) is a view illustrating processing of retrieving the first vector data using the indexes. Here, the second vector data generated from the query is indicated as a query. Further, distances between the second vector data and the centroid points are calculated, and L centroid points are selected in ascending order of distance. Distances between all the first vector data within the clusters to which the respective centroid points belong, and the second vector data are calculated, and N pieces of first vector data are returned as a result in ascending order of distance. Here, the first vector data for which the distance is the closest is indicated as a top 1.

While with the search space reduction-type (Ivfflat) index calculation, vector data for which the distance is close can be almost certainly found, a processing speed is likely to be low.

On the other hand, with the search space reduction-type (Ivfflat) index calculation, the processing speed changes depending on the number of the selected centroid points. For example, in a case where only one closest centroid point is selected, the number of pieces of the first vector data for which distances are to be calculated can be reduced, and thus, it requires only a small processing amount for calculation. On the other hand, in a case where the second vector data is located at a boundary of the clusters, omissions (although the first vector data is close, the first vector data is not selected) are likely to occur.

In contrast, for example, in a case where a plurality of (for example, L) centroid points is selected in ascending order of distance, even in a case where the second vector data is located at the boundary of the clusters, a possibility of occurrence of omissions decreases. However, distances are calculated for all the first vector data within the clusters to which the L centroid points belong, and thus, a processing amount increases.

In other words, while omissions are more likely to occur as the number of the centroid points selected in ascending order of distance is smaller, it requires only a small processing amount for calculation. On the other hand, while omissions are less likely to occur as the number of the selected centroid points is larger, it requires a more processing amount for calculation. In other words, there is a trade-off relationship between them.

It is therefore necessary to create clusters so that few omissions occur even with a few centroid points.

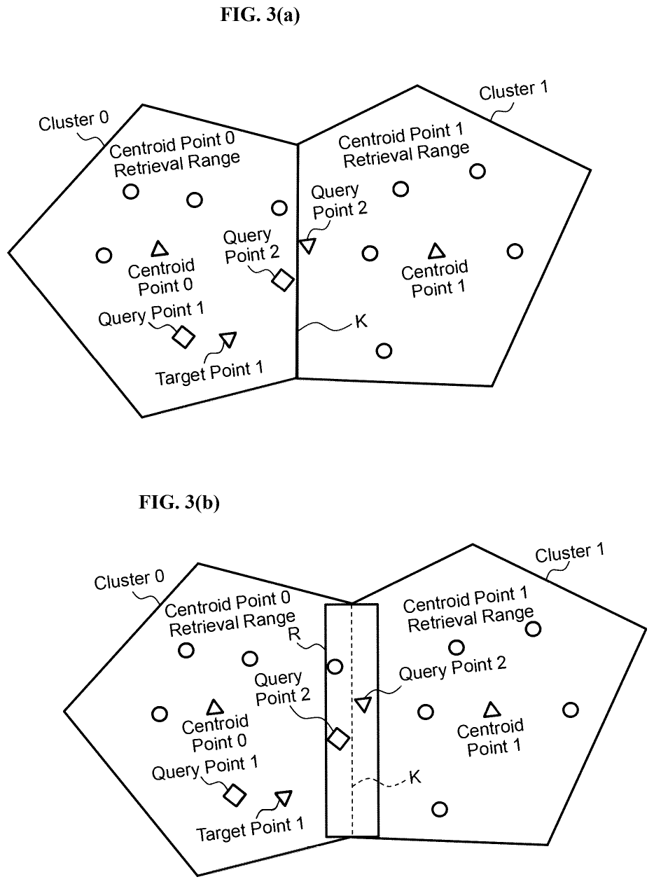

FIG. 3(a) is a view illustrating a case where omissions in selection occur in a case where only one closest centroid point is selected.

Here, a cluster 0 to which a centroid point 0 belongs, and a cluster 1 to which a centroid point 1 belongs are indicated. Here, for the sake of clarity, the cluster 0 and the cluster 1 are illustrated in a pentagonal shape in a two-dimensional plane. The cluster 0 and the cluster 1 are adjacent to each other and have a boundary K therebetween. Note that a numerical value subsequent to the centroid point is a number provided to the centroid, and hereinafter, may be referred to as a “centroid vector number”.

Here, in a case where the second vector data generated from the query is a query point 1, retrieval is performed for all the first vector data within the cluster 0, and retrieval is not performed for the first vector within the cluster 1. As a result, a target point 1 is selected as the first vector data of the closest distance, and in this case, a problem does not occur.

On the other hand, in a case where the second vector data is a query point 2 close to the boundary K of the cluster 0 and the cluster 1, in a similar manner, retrieval is performed for all the first vector data within the cluster 0, and retrieval is not performed for the first vector data within the cluster 1. In this case, the first vector data for which a distance is the closest to the query point 2 is a target point 2, but the target point 2 is located within the cluster 1 and thus, is not selected. In other words, the target point 2 is not selected, and an omission occurs.

FIG. 3(b) is a view illustrating a method for creating the clusters to which the present embodiment is applied.

In the present embodiment, a predetermined area R across the boundary K of the cluster 0 and the cluster 1 is set as an overlapping portion of the cluster 0 and the cluster 1. Note that here, for the sake of clarity, the predetermined area R is illustrated in a rectangular shape in a two-dimensional plane. In this case, the target point 2 that is the first vector data for which the distance is the closest to the query point 2 belongs to the predetermined area R. Further, the predetermined area R that is the overlapping portion is a target of retrieval when retrieval is performed for all the first vector data within the cluster 0. As a result, the target point 2 is selected, and an omission does not occur.

<Explanation of Method for Selecting First Vector Data Falling within Predetermined Area R>

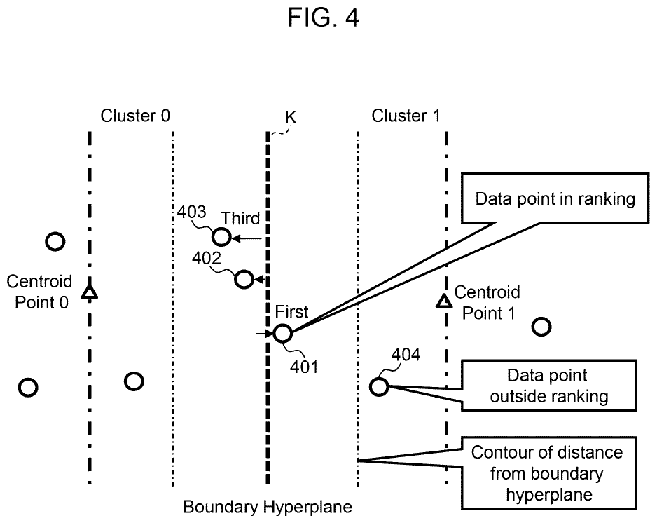

FIG. 4 is a view for explaining a method for selecting the first vector data falling within the predetermined area R.

FIG. 4 illustrates the boundary K of the cluster 0 and the cluster 1 as a boundary hyperplane. Further, a centroid point 0 and a centroid point 1 are illustrated respectively as the centroids of the cluster 0 and the cluster 1.

Here, a ranking of the first vector data is created in ascending order of distance from the boundary hyperplane, and top X pieces of the first vector data in ascending order of distance are made to belong to the predetermined area R in a case where the number of pieces of the first vector data becomes equal to or larger than a fixed number (X). Then, other pieces of the first vector data are made to belong to a cluster of the nearest centroid point. As a way of obtaining X, a method can be employed in which an average of the number of vectors belonging to one centroid is calculated, and n % thereof is obtained. In this case, n is adjustable. By adjusting n, the number of pieces of the first vector data falling within the predetermined area R can be adjusted. FIG. 4 illustrates a case where in consideration of contours of distances from the boundary hyperplane indicating portions at which the distances from the boundary hyperplane are the same, top three (the first to the third) pieces of the first vector data 401 to 403 in ascending order of distance from the boundary hyperplane are made to belong to the predetermined area R as data points within the ranking, and other piece of the first vector data 404 is set as data points outside the ranking.

Further, in consideration of distances from the centroids, the first vector data located closer to the centroid than the boundary hyperplane can be set as an exception.

### <Explanation of Functional Configuration of Vector Database Server 501>

Next, a functional configuration of a vector database server 501 that implements the above-described configuration will be described.

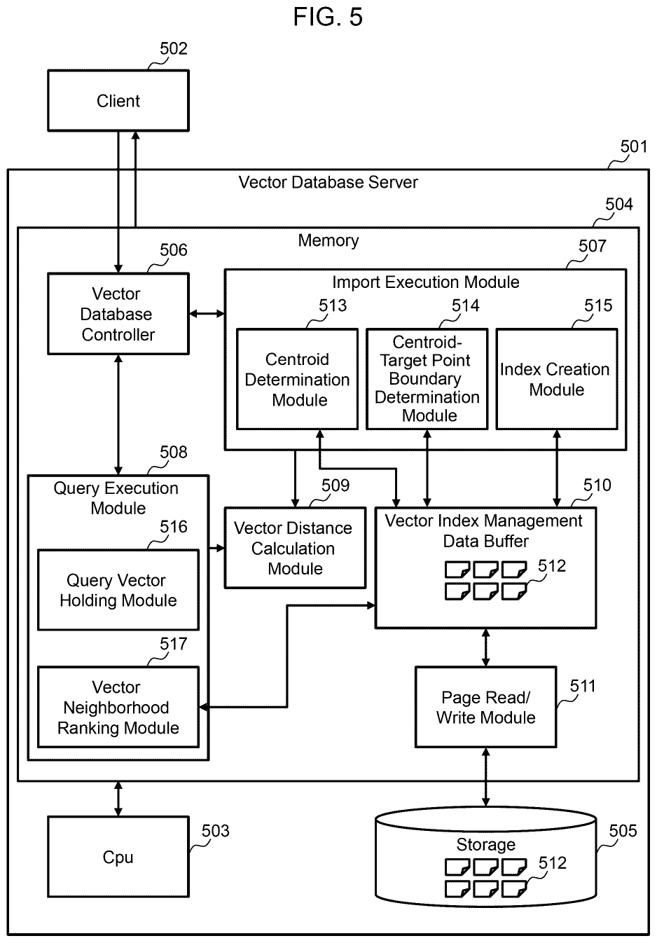

FIG. 5 is a view illustrating a hardware configuration and a functional configuration of the vector database server 501.

The vector database server 501 corresponds to the vector DB 102 in FIG. 1. The vector database server 501 can be, for example, used as a cloud server to be used when a service of the database system 100 is provided on cloud.

The vector database server 501, which is a computer apparatus, includes a central processing unit (CPU) 503, a memory 504, and a storage 505.

The CPU 503 is one example of a processor that is arithmetic means, and executes various kinds of software such as an OS (basic software) and an application program (application software).

The memory 504 is a storage area that stores various kinds of software, data to be used for execution of the software, and the like.

The storage 505 is a storage area that stores input data to various kinds of software, output data from various kinds of software, and the like. The storage 505 stores a data page 512, data of a document, and other various kinds of data which will be described in detail later.

The memory 504 stores application programs for implementing functions of a vector database controller 506, the import execution module 507, the query execution module 508, a vector distance module 509, a vector index management data buffer 510, and a page read/write module 511. The CPU 503 executes these application programs to implement these functions.

The vector database controller 506 controls the entire vector database server 501. Further, the vector database controller 506 accepts a query from the client 502.

The import execution module 507 clusters the first vector data generated from chunks obtained by dividing a document, registers centroid points as indexes and creates a list of vector data belonging to the clusters in which the centroid points exist.

The query execution module 508 retrieves the first vector data close to the second vector data generated from the query using the created list and creates a candidate list of the retrieved first vector data of a predetermined number of pieces in ascending order of distance.

The vector distance module 509 calculates distances between the first vector data and the second vector data. The query execution module 508 retrieves the first vector data close to the second vector data based on the distances.

The vector index management data buffer 510 creates or changes the data page 512.

The page read/write module 511 reads and writes the data page 512 from and in the storage 505.

The import execution module 507 clusters the first vector data and creates a list of the first vector data. In other words, the import execution module 507 executes pre-processing to be performed until processing is executed on the query. This can be also said as processing of constructing a database of vector data for providing an answer to the query.

The import execution module 507 includes a centroid determination module 513, a centroid-target point boundary determination module 514, and an index creation module 515.

The centroid determination module 513, which is one example of a clustering unit, divides vector data (first vector data) into a plurality of clusters through clustering and determines centroids of the respective clusters, the first vector data being data obtained by vectorizing chunks, the chunks being obtained by dividing a document.

The centroid-target point boundary determination module 514 extracts the first vector data included in the predetermined area R explained with FIG. 3 and FIG. 4.

The index creation module 515 registers the centroid points as indexes. Further, the index creation module 515, which is one example of a list creation unit, creates a list of the first vector data belonging to the clusters and the first vector data included in the predetermined area R across the boundary K of the clusters.

The query execution module 508 compares the first vector data and the second vector data to retrieve the first vector data close to the second vector data. This can be also said as processing for providing an answer to the query.

The query execution module 508 includes a query vector holding module 516 and a vector neighborhood ranking module 517.

The query vector holding module 516 holds the second vector data created for the query.

The vector neighborhood ranking module 517, which is one example of a retrieval unit, upon retrieval of the first vector data close to the second vector data by performing comparison between the first vector and the second vector created for the query based on the list created at the index creation module 515, performs the comparison by using the first vector data included in the cluster to which the second vector data belongs and the first vector data included in the predetermined area R set for the boundary K of the cluster to which the second vector data belongs.

### <Explanation of Data Structure of Data Page 512>

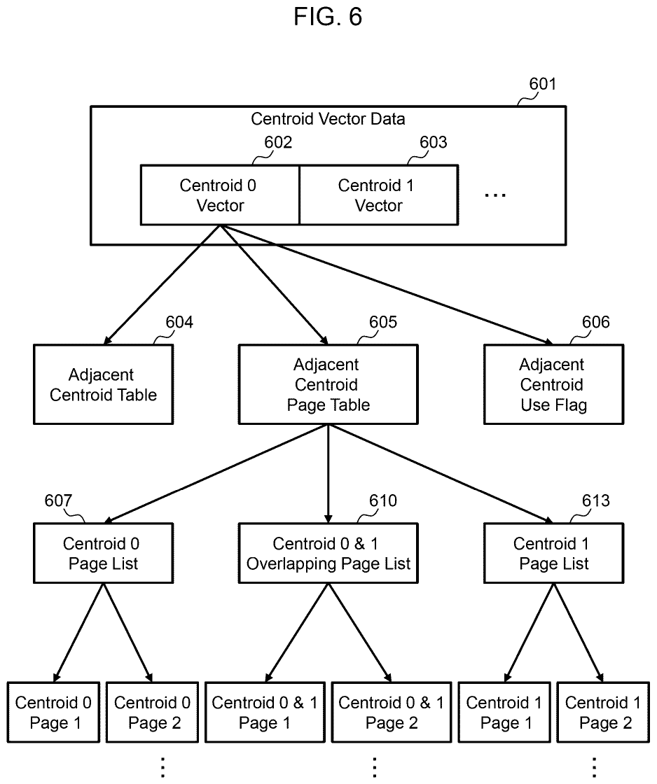

FIG. 6 is a view illustrating a data structure of the data page 512 to be used in the present embodiment.

In the present embodiment, respective pieces of data are associated in a tree structure.

In a first layer of the tree structure, centroid vector data 601 that is vector data of the centroids of the respective clusters is stored. Here, it indicates that a centroid 0 vector 602 that is vector data of the centroid point 0, a centroid 1 vector 603 that is vector data of the centroid point 2, . . . , are stored.

In a second layer, three types of table data are stored. The table data is an adjacent centroid table 604, an adjacent centroid page table 605, and an adjacent centroid use flag table 606. These tables will be described in detail later.

In a third layer, page lists associated with the adjacent centroid page table 605 are stored. In the page lists, the first vector data included in the clusters to which the respective centroids belong, and the first vector data included in the predetermined area R set across the boundary K of the clusters to which the respective centroids belong, are stored. Here, a centroid 0 page list 607 that is a page list for the centroid point 0, a centroid 0 & 1 overlapping page list 610 that is a page list for the predetermined area R across the boundary K of the clusters of the centroid point 0 and the centroid point 1, and a centroid 1 page list 613 that is a page list for the centroid point 1, are stored.

Each page list includes a plurality of pages as illustrated in a fourth layer. Here, it indicates that the centroid 0 page list 607 includes a centroid 0 page 1, a centroid 0 page 2, . . . . Further, it indicates that the centroid 0 & 1 overlapping page list 610 includes a centroid 0 & 1 page 1, a centroid 0 & 1 page 2, . . . . Still further, it indicates that the centroid 1 page list 613 includes a centroid 1 page 1, a centroid 1 page 2, . . . .

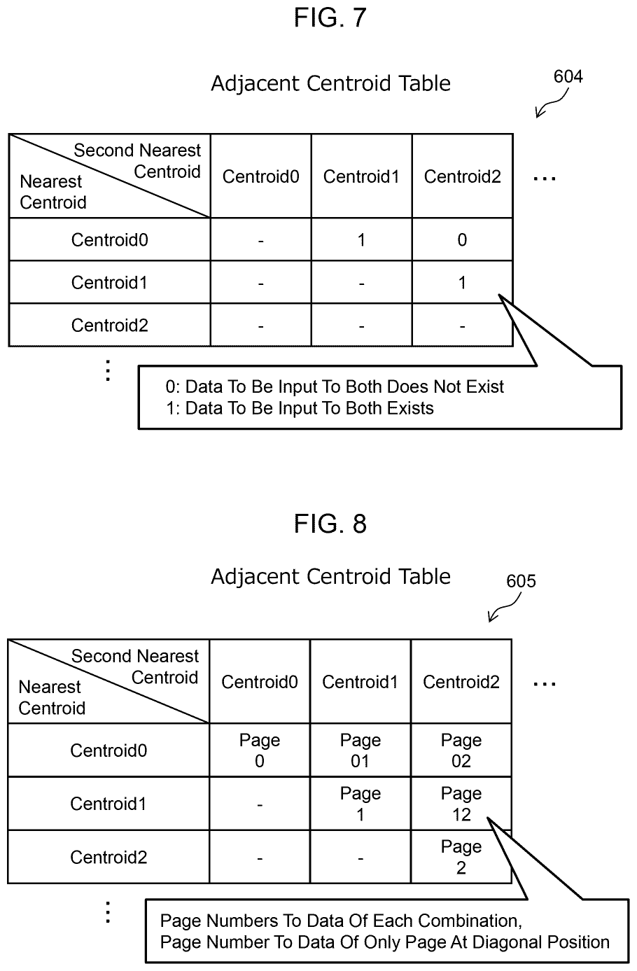

FIG. 7 is a view indicating a data structure of the adjacent centroid table 604.

The adjacent centroid table 604 is one example of a first table indicating whether or not the first vector data exists in the predetermined area R. Here, the adjacent centroid table 604 is created as a relationship between two centroids. Then, in a case where a flag described at an intersection of the two centroids is “0”, it indicates that the clusters to which the respective centroids belong are not adjacent to each other, or the first vector data does not exist in the predetermined area R set for the boundary K of the clusters to which these centroids belong. In contrast, in a case where the flag described at the intersection of the two centroids is “1”, it indicates that the first vector data exists in the predetermined area R. Note that while here, the adjacent centroid table 604 is created as the relationship between two centroids, the adjacent centroid table 604 may be created as a relationship between two clusters.

By referring to the adjacent centroid table 604, it is possible to determine whether or not retrieval is to be performed while adding the first vector data included in the predetermined area R. For example, in a case where the second vector data is included in the cluster 0 to which the centroid point 0 belongs, data of the centroid point 1 with respect to the centroid point 0 is “1”. Thus, the predetermined area R is set between these centroids (between the cluster 0 and the cluster 1), and the first vector data exists there. Thus, it is necessary to perform retrieval also for this portion in addition to the cluster 0. In contrast, data of the centroid point 2 with respect to the centroid point 0 is “0”. Thus, the predetermined area R is not set between these centroids (between the cluster 0 and the cluster 2), and the first vector data does not exist there. It is therefore not necessary to perform retrieval for this portion.

FIG. 8 is a view indicating a data structure of the adjacent centroid page table 605.

The adjacent centroid page table 605 is one example of a second table indicating a list of the first vector data included in the predetermined area R. Here, the adjacent centroid page table 605 is created as a relationship between two centroids. Further, a page list between the centroids is indicated. For example, a page list at an intersection of the centroid point 0 and the centroid point 0 is a page list for the centroid point 0 and is the centroid 0 page list 607 in FIG. 6. Further, a page list of the centroid point 0 and the centroid point 1 is the centroid 0 & 1 overlapping page list 610. Still further, a page list of the centroid point 1 and the centroid point 1 is a page list of the centroid point 1 and is the centroid 1 page list 613. By referring to the adjacent centroid page table 605, it is possible to specify the page list for the first vector data included in the predetermined area R. In other words, existence of the first vector data included in the predetermined area can be known from the adjacent centroid page table 605. Note that here, the adjacent centroid page table 605 is created as the relationship between two centroids, the adjacent centroid page table 605 may be created as a relationship between two clusters.

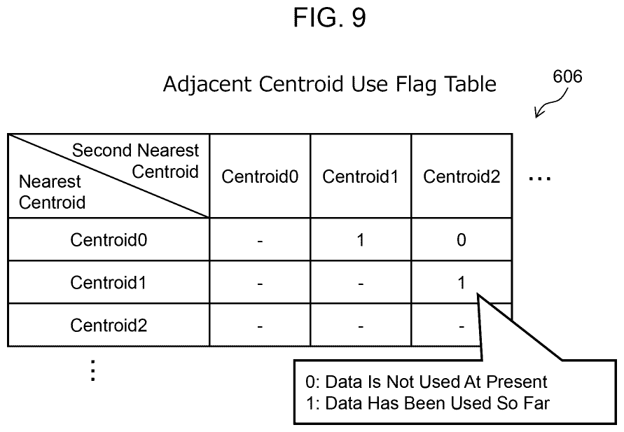

FIG. 9 is a view indicating a data structure of the adjacent centroid use flag table 606.

The adjacent centroid use flag table 606 is one example of a third table indicating whether or not the predetermined area R has been used upon retrieval. Here, the adjacent centroid use flag table 606 is created as the relationship between two centroids. An adjacent centroid flag is described at the intersection of the two centroids. Then, in a case where the adjacent centroid flag is “0”, it indicates that the predetermined area R set for the boundary K of the clusters to which these centroids belong has not been used yet for retrieval. On the other hand, in a case where the adjacent centroid flag is “1”, it indicates that the predetermined area R has already been used for retrieval. Note that here, the adjacent centroid use flag table 606 is created as a relationship between two centroids, the adjacent centroid use flag table 606 may be created as a relationship between two clusters.

By referring to the adjacent centroid use flag table 606, it is possible to prevent comparison for the predetermined area R from being performed in an overlapped manner. By this means, a processing speed upon retrieval is improved. For example, if the second vector data is included in the cluster 0 to which the centroid point 0 belongs, and retrieval is performed for the centroid 0 & 1 overlapping page list 610, data of the centroid point 1 with respect to the centroid point 0 changes from “0” to “1”. By this means, it indicates that the retrieval has already ended for the predetermined area R between the cluster 0 and the cluster 1. Then, when the cluster 1 becomes a retrieval target, retrieval has already ended for the predetermined area R between the cluster 0 and the cluster 1, and thus, it is not necessary to perform retrieval. Thus, with reference to the data of the centroid point 1 with respect to the centroid point 0 being “1”, it can be known that it is not necessary to perform retrieval, and it is possible to prevent comparison for the predetermined area R from being performed in an overlapped manner.

### <Explanation of Operation of Vector Database Server 501>

Operation of the vector database server 501 will be described next.

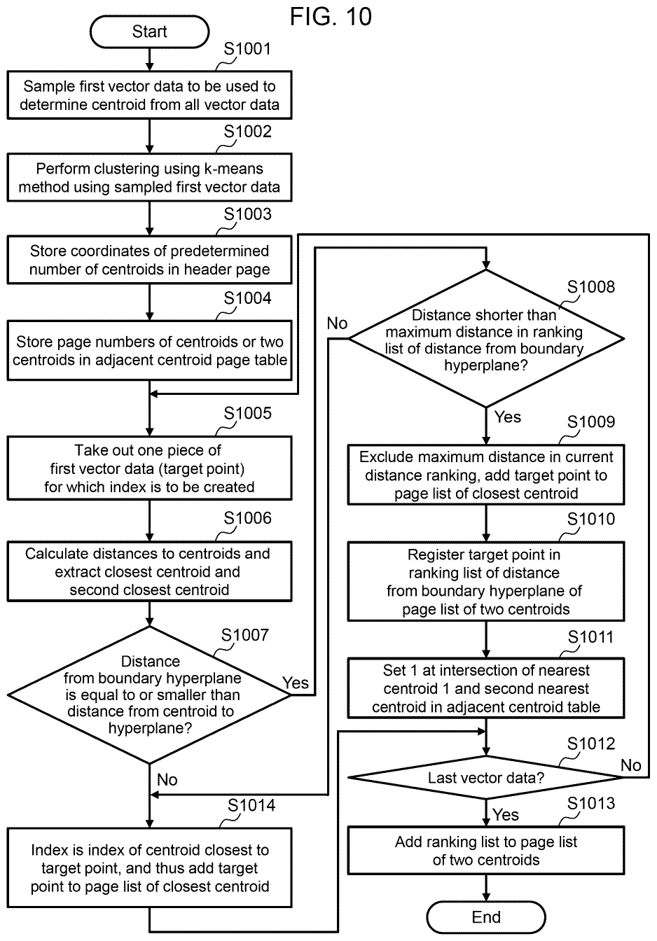

FIG. 10 is a flowchart for explaining operation of the import execution module 507 of the vector database server 501. In other words, FIG. 10 indicates pre-processing to be performed until processing is executed on the query.

First, the import execution module 507 samples the first vector data to be used for determination of the centroid from all the vector data (S1001).

Next, the import execution module 507 performs clustering using a k-means method using the sampled first vector data (S1002).

Then, the import execution module 507 stores coordinates of a predetermined number of centroids in a header page (S1003).

Then, the import execution module 507 stores centroid vector numbers of the respective centroids or two centroids in the adjacent centroid page table 605 (S1004).

Further, the import execution module 507 takes out one piece of the first vector data (target point) for which an index is to be created (S1005).

Then, the import execution module 507 calculates distances to the respective centroids for the taken out first vector data and extracts the closest centroid and the second closest centroid (S1006).

Then, the import execution module 507 determines whether or not a distance from the boundary hyperplane for the taken out first vector data is equal to or smaller than a distance from the centroid to the boundary hyperplane (S1007).

As a result, in a case where the distance from the boundary hyperplane is equal to or smaller than the distance from the centroid to the boundary hyperplane (S1007: Yes), the import execution module 507 determines whether or not the distance is shorter than a maximum distance in the ranking list of distance from the boundary hyperplane (S1008).

Then, in a case where the distance is shorter than the maximum distance in the ranking list of distance from the plane (S1008: Yes), the import execution module 507 excludes the maximum distance in the current ranking of distance from the ranking. Then, the import execution module 507 adds a target point to the page list of the closest centroid (S1009).

Then, the import execution module 507 registers the target point in the ranking list of distance from the boundary hyperplane of the page list of two centroids (S1010).

Then, the import execution module 507 sets 1 to an intersection of the nearest centroid and the second nearest centroid of the adjacent centroid table 604 (S1011).

Further, the import execution module 507 determines whether or not the vector data acquired in S1001 is the last vector data (S1012).

Then, in a case where the vector data is the last vector data (S1012: Yes), the import execution module 507 adds the ranking list to the page list of the two centroids (S1013).

On the other hand, in a case where the vector data is not the last vector data (S1012: No), the processing returns to S1005.

Further, in a case where the distance from the boundary hyperplane exceeds the distance from the centroid to the boundary hyperplane in S1007 (S1007: No), and in a case where the distance is equal to or longer than the maximum distance of the ranking list of distance from the plane in S1008 (S1008: No), the index becomes an index only for the centroid closest from the target point, and thus, the import execution module 507 adds the target point to the page list of the closest centroid (S1014). Then, the processing proceeds to S1012.

In the processing from S1007 to S1010, the import execution module 507 determines the first vector data included in the predetermined area R based on a position of the centroid and a position of the boundary K. This makes it possible to extract the first vector data located close to the boundary K. More specifically, the first vector data included in the predetermined area R is determined from distances between the first vector data, and the position of the centroid and the position of the boundary K. By this means, the first vector data located close to the boundary K can be extracted by the distances in the vector space. This processing is performed by the index creation module 515.

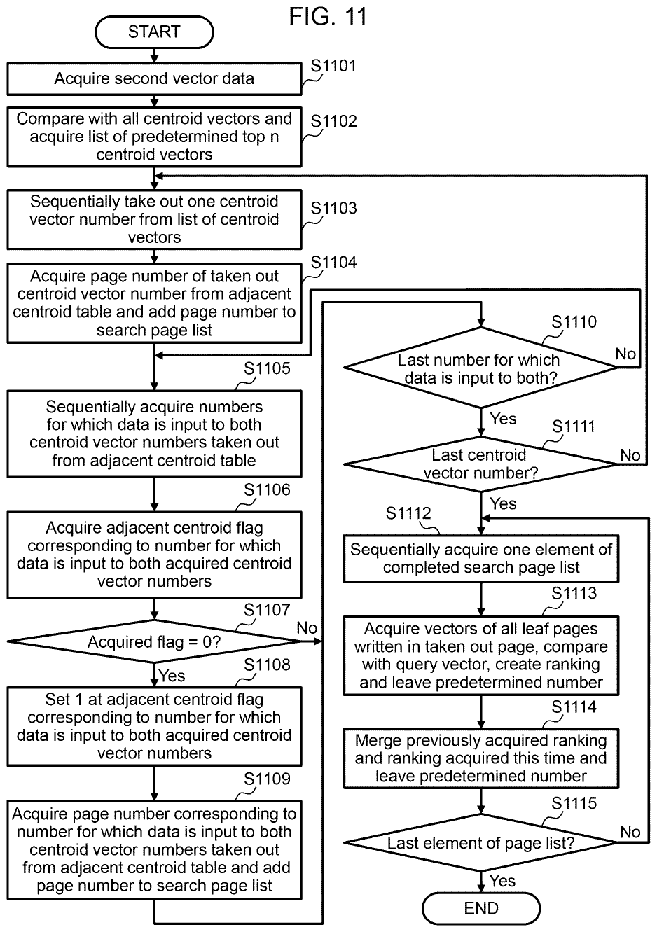

FIG. 11 is a flowchart for explaining operation of the query execution module 508 of the vector database server 501. In other words, FIG. 11 indicates processing of retrieving the first vector data close to the second vector data for providing an answer to the query.

First, the query execution module 508 acquires the second vector data that is vector data of the query (S1101).

Then, the query execution module 508 compares the second vector data and all the vector data of the centroids and acquires a list of predetermined top n pieces of vector data of the centroids (S1102).

Further, the query execution module 508 sequentially takes out one centroid vector number from the list of the vector data of the centroids (S1103).

Then, the query execution module 508 acquires a page number corresponding to the centroid vector number taken out in S1103 from the adjacent centroid table 604 and adds the page number to a search page list (S1104).

Then, the query execution module 508 sequentially acquires a number for which data is input to both the taken out centroid vector numbers from the adjacent centroid table 604 (S1105).

Further, the query execution module 508 acquires an adjacent centroid flag corresponding to the number for which data is input to both the acquired centroid vector numbers (S1106).

Then, the query execution module 508 determines whether or not the acquired adjacent centroid flag is 0 (S1107).

As a result, in a case where the acquired adjacent centroid flag is 0 (S1107: Yes), the query execution module 508 sets 1 at the adjacent centroid flag corresponding to the number for which data is input to both the acquired centroid vector numbers (S1108). Note that in a case where the acquired adjacent centroid flag is not 0 (is 1) (S1107: No), the processing proceeds to S1110.

Further, the query execution module 508 acquires a page number corresponding to the number for which data is input to both the centroid vector numbers and adds the page number to the search page list (S1109).

Then, the query execution module 508 determines whether or not the number is the last number for which data is input to both (S1110).

As a result, in a case where the number is the last number for which data is input to both (S1110: Yes), the query execution module 508 determines whether or not the number is the last centroid vector number (S1111). Note that in a case where the number is not the last number for which data is input to both (S1110: No), the processing returns to S1105.

As a result, in a case where the number is the last centroid vector number (S1111: Yes), the query execution module 508 sequentially acquires one element from the completed search page list (S1112). Note that in a case where the number is not the last centroid vector number (S1111: No), the processing returns to S1103.

Then, the query execution module 508 acquires the first vector data included in all the page lists written in the taken out element and compares the first vector data with the second vector data, creates a ranking and leaves a predetermined number of pieces (S1113).

Further, the query execution module 508 merges the previously acquired ranking and the ranking acquired this time and leaves a predetermined number of pieces (S1114).

Then, the query execution module 508 determines whether or not the element is the last element in the search page list (S1115).

As a result, in a case where the element is the last element (S1115: Yes), the query execution module 508 ends a series of processing. Note that in a case where the element is not the last element (S1115: No), the processing returns to S1112.

Further, it is possible to mix a case where retrieval is performed for the entire adjacent cluster and a case where retrieval is performed only for the set predetermined area R of the boundary K with the adjacent cluster. This can be also said as the query execution module 508 performing comparison by further using all the first vector data included in the cluster adjacent to the cluster to which the second vector data belongs, the cluster being defined based on the position of the centroid. This improves reliability of retrieval. Further, it can be also said as the query execution module 508 distinguishing between a case where all the first vector data included in the cluster adjacent to the cluster to which the second vector data belongs is used, and a case where the first vector data included in the predetermined area R set for the cluster to which the second vector data belongs is used. By this means, the processing speed is less likely to decrease even in a case where the reliability of retrieval is improved.

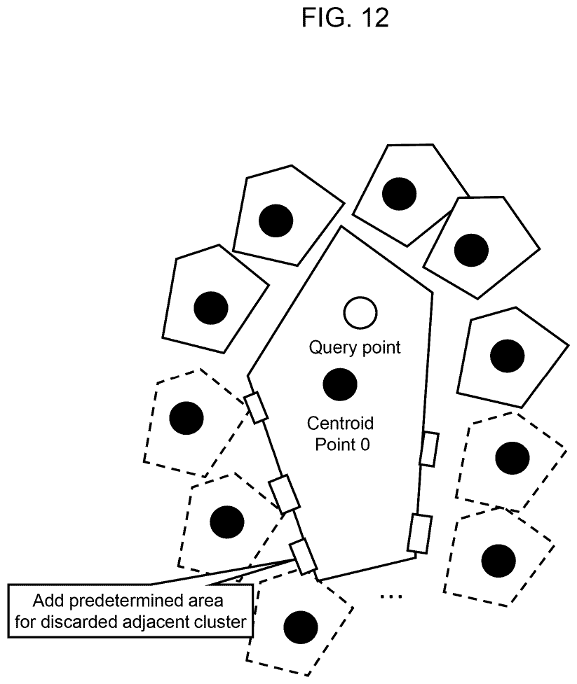

FIG. 12 is a view for processing in the case of mixture of a case where retrieval is performed for the entire adjacent cluster and a case where retrieval is performed only for the set predetermined area R of the boundary K with the adjacent cluster.

In this case, the query execution module 508 uses all the included first vector data for clusters of the number determined in advance in ascending order of distance of the position of the centroid for the clusters adjacent to the cluster to which the second vector data belongs, and uses the first vector data included in the predetermined area R set for the cluster to which the second vector data belongs for the remaining clusters. By this means, for clusters for which a possibility that the first vector data close to the second vector data exists is high, reliability of retrieval is improved by using all the first vector data, and for clusters for which a possibility that the first vector data close to the second vector data exists is low, a processing speed is improved by performing retrieval only for the predetermined area R.

FIG. 12 indicates that a number of adjacent clusters exist for the centroid point 0 at which the query point exists. For example, even if there are two adjacent clusters for each dimension in 128 dimensions, 256 adjacent clusters exist. In the current search space reduction-type (Ivfflat) index calculation, 50 adjacent clusters are selected at most in ascending order of distance among these and used to perform retrieval. In other words, 206 adjacent clusters are discarded, thereby recall (accuracy of retrieval) degrades. To avoid this, for example, for 50 adjacent clusters (50 clusters in ascending order of distance of the position of the centroid), retrieval is performed for (all) the first vector data included in these. On the other hand, for the remaining 206 adjacent clusters (remaining clusters), retrieval is performed for the first vector data included in the predetermined area R, and retrieval is not performed for other first vector data included in these clusters.

By this means, the recall increases, and the number of adjacent clusters to be selected can be reduced. There is a trade-off relationship between the number of clusters for which retrieval is performed for all the data, and the processing speed. Thus, as the number of clusters for which retrieval is performed for all the data increases, the recall is improved, but the processing speed decreases. On the other hand, as the number of clusters for which retrieval is performed for all the data decreases, the recall degrades, but the processing speed is improved. It is therefore possible to adjust the number of clusters for which retrieval is performed for all the data depending on the required processing speed and calculation capability.

### Second Embodiment

While in the first embodiment, the import execution module 507 determines the first vector data included in the predetermined area R based on the position of the centroid and the position of the boundary K, the first vector data included in the predetermined area R can be defined based on a cosine similarity defined based on a relationship between the first vector data and the position of the centroid. In this case, the first vector data located close to the boundary K can be extracted by the cosine similarity.

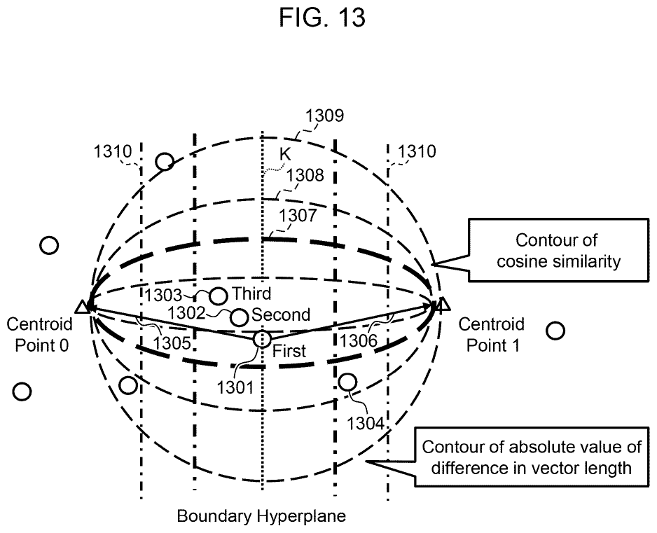

FIG. 13 is a view illustrating a method for selecting the first vector data included in the predetermined area R by the cosine similarity defined based on the relationship between the first vector data and the position of the centroid.

FIG. 13 illustrates the boundary hyperplane as the boundary K of the cluster 0 and the cluster 1. Further, the centroid point 0 and the centroid point 1 are respectively illustrated as the centroids of the cluster 0 and the cluster 1.

Here, a cosine similarity (that is, an angle) between two vectors 1305, 1306 with which the first vector data 1301 can be connected to the nearest centroid point and the second nearest centroid point will be considered. Further, in a case where a value of the cosine similarity is equal to or smaller than a fixed value (that is, between the two centroids), and in a case where an absolute value of a difference between vector lengths of the two vectors 1305, 1306 is equal to or smaller than a fixed value, the first vector data is made to belong to the predetermined area R. Other first vector data is made to belong to a cluster of the nearest centroid point. By adjusting the fixed value to be set for the value of the cosine similarity, a contour 1307 of the cosine similarity in FIG. 13 changes as a contour 1308 or a contour 1309, and the predetermined area R can be adjusted in a vertical direction in the drawing. Further, by adjusting the fixed value to be set for the value of the cosine similarity, a contour 1310 of the absolute value of the difference between the vector lengths in FIG. 13 changes, and the predetermined area R can be adjusted in a horizontal direction in the drawing. FIG. 13 illustrates a case where the top three pieces of the first vector data 1301 to 1303 for which distances from the boundary hyperplane are small (the smallest to the third smallest) are made to belong to the predetermined area R, and other first vector data 1304 is set as being outside the ranking.

Further, a ranking is created for the first vector data in ascending order of absolute value of difference in vector length, and in a case where the number of pieces of the first vector data becomes equal to or larger than a fixed number (X), only the top X vectors in ascending order of absolute value may be made to belong the predetermined area R, and other vectors may be made to belong to the cluster of the nearest centroid point. As a way of obtaining X, it is possible to employ a method in which an average of the number of vectors belonging to one centroid is calculated, and n % thereof is obtained. In this case, n is adjustable. By adjusting n, it is possible to directly adjust the number of the first vectors falling within the predetermined area R.

According to this method, compared to the first embodiment, it is possible to improve the processing speed when the first vector data included in the predetermined area R is determined. On the other hand, regarding the accuracy of retrieval, a possibility that omissions may occur become higher than in the first embodiment. In other words, a range indicated by the contour 1307 of the cosine similarity is selected with this method. This range can be changed as the contour 1308 and the contour 1309 by changing the fixed value as described above, but it is difficult to cover upper and lower portions in the drawing, which results in increasing a possibility that omissions may occur.

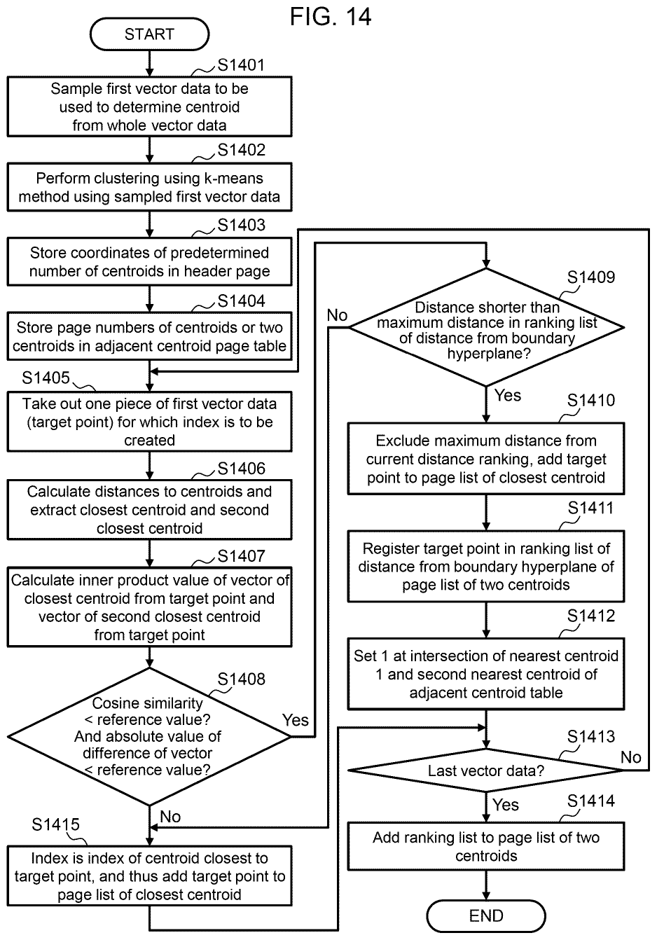

FIG. 14 is a flowchart for explaining operation of the import execution module 507 in the second embodiment.

Processing from S1401 to S1406 and from S1409 to S1415 in FIG. 14 is the same as the processing from S1001 to S1006 and from S1008 to S1014 in FIG. 10, and only processing from S1407 to S1408 is different. Thus, description will be provided below for the processing from S1407 to S1408 different from FIG. 10.

The import execution module 507 calculates an inner product value of the vector of the centroid closest to the target point and the vector of the centroid second closest to the target point (S1407).

Then, the import execution module 507 determines whether or not the cosine similarity is less than a reference value and the absolute value of the difference in vector length is less than a reference value (S1408).

As a result, in a case where the condition of S1408 is satisfied (S1408: Yes), the processing proceeds to S1409, and in a case where the condition of S1408 is not satisfied (S1408: No), the processing proceeds to S1415.

According to the vector database server 501 and the database system 100 described in detail above, it is possible to balance the reliability of retrieval and the processing speed.

### <Explanation of Data Retrieval Method>

The processing to be performed by the vector database server 501 is implemented by coordination of software and hardware resources. In other words, respective functions of the vector database server 501 are implemented by the processor such as the CPU 503 provided in the vector database server 501 loading programs that implement the functions of the vector database server 501 to the memory 504 and executing the programs.

Thus, the processing to be performed by the above-described vector database server 501 can be regarded as a data retrieval method by a processor executing a program recorded in a memory, the data retrieval method including dividing first vector data that is data obtained by vectoring chunks obtained by dividing a document, into a plurality of clusters through clustering and determining a centroid of each of the clusters, creating a list of the first vector data belonging to the clusters and the first vector data included in a predetermined area R across a boundary of the clusters, and upon retrieval of the first vector data close to second vector data created for a query by performing comparison between the first vector data and the second vector data based on the list, performing the comparison by using the first vector data included in a cluster to which the second vector data belongs and the first vector data included in the predetermined area R set for a boundary of the cluster to which the second vector data belongs. This makes it possible to provide a data retrieval method capable of balancing reliability of retrieval and a processing speed.

Note that the present invention is not limited to the above-described embodiments and includes various modifications. For example, the above-described examples are described in detail to explain the present invention in an easily understood manner, and the present invention is not necessarily limited to one including all the described components. Further, some of components of a certain example can be replaced with components in other examples, and to components of a certain example, components of other examples can be added. Further, other components can be added to some components of each example, or some components of each example can be deleted or replaced.

Further, some or all of the components, the functions, the processing units, the processing means, and the like, described above may be implemented by hardware by being designed with, for example, an integrated circuit. Further, the components, the functions, and the like, described above may be implemented by software by the processor interpreting and executing programs that implement the respective functions. Information regarding the programs that implement the respective functions, tables, files, and the like, can be recorded in a memory, a recording apparatus such as a hard disk and a solid state drive (SSD) or a recording medium such as an IC card, an SD card and a DVD.

Further, only control lines and information lines considered to be necessary for description are illustrated, and not all the control lines and information lines of a product are necessarily illustrated. Actually, almost all the components may be considered to be connected to each other.

### REFERENCE SIGNS LIST

100 database system
501 vector database server
503 CPU
504 memory
505 storage
506 vector database controller
507 import execution module
508 query execution module
512 data page
513 centroid determination module
514 centroid-target point boundary determination module
515 index creation module
516 query vector holding module
517 vector neighborhood ranking module
601 centroid vector data
604 adjacent centroid table
605 adjacent centroid page table
606 adjacent centroid use flag table

1. A database apparatus comprising:
a clustering unit that divides first vector data into a plurality of clusters through clustering and determines a centroid of each of the clusters, the first vector data being data obtained by vectorizing chunks, the chunks being obtained by dividing a document;
a list creation unit that creates a list of the first vector data belonging to the clusters and the first vector data included in a predetermined area across a boundary of the clusters; and
a retrieval unit that, upon retrieval of the first vector data close to second vector data created for a query by performing comparison between the first vector data and the second vector based on the list, performs the comparison by using the first vector data included in a cluster to which the second vector data belongs and the first vector data included in the predetermined area set for a boundary of the cluster to which the second vector data belongs.

2. The database apparatus according to claim 1, wherein the list creation unit determines the first vector data included in the predetermined area based on a position of the centroid and a position of the boundary.

3. The database apparatus according to claim 2, wherein the list creation unit determines the first vector data included in the predetermined area based on distances between the first vector data, and the position of the centroid and the position of the boundary.

4. The database apparatus according to claim 2, wherein the list creation unit determines the first vector data included in the predetermined area based on a cosine similarity defined based on a relationship between the first vector data and the position of the centroid.

5. The database apparatus according to claim 1, wherein the retrieval unit performs the comparison by further using all the first vector data included in a cluster adjacent to the cluster to which the second vector data belongs, the cluster being defined based on a position of the centroid.

6. The database apparatus according to claim 5, wherein the retrieval unit distinguishes between a case where all the first vector data included in the cluster adjacent to the cluster to which the second vector data belongs is used, and a case where the first vector data included in the predetermined area set for the cluster to which the second vector data belongs is used.

7. The database apparatus according to claim 6, wherein the retrieval unit uses all the first vector data included in the cluster adjacent to the cluster to which the second vector data belongs for clusters corresponding to the number determined in advance in ascending order of distance of the position of the centroid, and uses the first vector data included in the predetermined area set for the cluster to which the second vector data belongs for the remaining clusters.

8. The database apparatus according to claim 1, wherein
the list creation unit creates a first table indicating whether or not the first vector data exists in the predetermined area as a relationship between the centroids or between the clusters, and
the retrieval unit determines whether or not the first vector data included in the predetermined area is to be retrieved by referring to the first table.

9. The database apparatus according to claim 1, wherein
the list creation unit creates a second table indicating a list of the first vector data included in the predetermined area as a relationship between the centroids or between the clusters, and
the retrieval unit specifies the list of the first vector data included in the predetermined area by referring to the second table.

10. The database apparatus according to claim 1, wherein the retrieval unit creates a third table indicating whether or not the predetermined area has been used for retrieval as a relationship between the centroids or between the clusters and prevents comparison for the predetermined area from being performed in an overlapped manner by referring to the third table.

11. A data retrieval method to be performed by a processor executing a program recorded in a memory, the data retrieval method comprising:
dividing first vector data into a plurality of clusters through clustering and determining a centroid of each of the clusters, the first vector data being data obtained by vectorizing chunks, the chunks being obtained by dividing a document;
creating a list of the first vector data belonging to the clusters and the first vector data included in a predetermined area across a boundary of the clusters; and
upon retrieval of the first vector data close to second vector data created for a query by performing comparison between the first vector data and the second vector data based on the list, performing the comparison by using the first vector data included in a cluster to which the second vector data belongs and the first vector data included in the predetermined area set for a boundary of the cluster to which the second vector data belongs.

12. A database system comprising:
a terminal apparatus to which a client inputs a query;
a document management apparatus that divides a document into chunks; and
a database apparatus that retrieves the chunks close to the query,
wherein the database apparatus includes:
a clustering unit that divides first vector data that is data obtained by vectorizing the chunks, into a plurality of clusters through clustering and determines a centroid of each of the clusters;
a list creation unit that creates a list of the first vector data belonging to the clusters and the first vector data included in a predetermined area across a boundary of the clusters; and
a retrieval unit that upon retrieval of the first vector data close to second vector data created for the query by performing comparison between the first vector data and the second vector data based on the list, performs the comparison by using the first vector data included in a cluster to which the second vector data belongs and the first vector data included in the predetermined area set for a boundary of the cluster to which the second vector data belongs.
